(19) United States
(12) Patent Application Publication
(10) Pub. No.: US 2011/0135982 A1
(43) Pub. Date: Jun. 9, 2011

(54) NEGATIVE ELECTRODE FOR NON-AQUEOUS ELECTROLYTE SECONDARY BATTERY AND FABRICATION METHOD THEREOF, AND NON-AQUEOUS ELECTROLYTE SECONDARY BATTERY

(76) Inventors: Yoshiyuki Muraoka, Osaka (JP); Masaya Ugaji, Osaka (JP); Shinji Kasamatsu, Osaka (JP)

(21) Appl. No.: 13/058,791

(22) PCT Filed: Jun. 29, 2010
(86) PCT No.: PCT/JP2010/004288

§ 371 Date: Feb. 11, 2011

(30) Foreign Application Priority Data
Jun. 30, 2009 (JP) 2009-154849

(51) Int. Cl. H01M 4/13; H01M 4/62; F27D 7/00; H01M 10/36; H01M 10/04

(52) U.S. Cl. 429/94; 429/209; 29/623.1; 29/623.5; 432/23

(57) ABSTRACT

A negative electrode, whose tensile strength is 15 N/cm or lower when the percentage elongation in the longitudinal direction is 1%, is used in a non-aqueous electrolyte secondary battery including: a flat electrode group 10 including a positive electrode, the negative electrode and a separator; and a non-aqueous electrolyte, which are housed in a prismatic battery case. This negative electrode includes a negative electrode current collector and a negative electrode active material layer which includes: (1) a negative electrode active material which expands and contracts by absorbing and desorbing lithium ions; (2) a rubber binder whose thermal decomposition temperature is equal to or higher than the softening temperature of the negative electrode current collector; (3) a water-soluble polymer A whose thermal decomposition temperature is equal to or higher than the softening temperature of the negative electrode current collector; and (4) a water-soluble polymer B whose thermal decomposition temperature is equal to or higher than the softening temperature of the negative electrode current collector and whose degree of swelling relative to the non-aqueous electrolyte is lower than that of the water-soluble polymer A. Formed on the surface of the negative electrode active material is a coating layer including the water-soluble polymer A.

### TECHNICAL FIELD

The present invention relates to a negative electrode for a non-aqueous electrolyte secondary battery and a fabrication method thereof, and a non-aqueous electrolyte secondary battery. More specifically, the present invention relates to improving a negative electrode for a non-aqueous electrolyte secondary battery.

### BACKGROUND ART

Non-aqueous electrolyte secondary batteries are widely used as a power source for driving electronic equipments, due to having high operating voltage and high energy density. Also, in recent years, development has been proceeding rapidly to enable use of non-aqueous electrolyte secondary batteries for applications which require high output, such as storing energy and driving electric vehicles, and is partially and gradually being put into practical use.

As an exemplary non-aqueous electrolyte secondary battery, a lithium-ion secondary battery comprising: a positive electrode containing LiCoO₂ having a hexagonal structure and a high operating voltage and capable of yielding a high energy density; and a negative electrode containing graphite having high capacity and capable of making the discharge potential constant, can be given.

Meanwhile, with increase of functions in electronic equipments and increase in demand for electric vehicles with small amount of carbon dioxide emission, further enhancement in capacity is demanded of non-aqueous electrolyte secondary batteries, for their use as respective power sources for electronic equipments and electric vehicles. One of the problems with respect to enhancing the capacity of a non-aqueous electrolyte secondary battery is that related to the enhancement of adhesion between the negative electrode current collector and the negative electrode active material layer. Graphite expands and contracts by charge and discharge, and its volume during charge is about 10% larger than its volume during discharge. Therefore, when the tensile strength of the negative electrode current collector is high, a slip is caused between the negative electrode active material layer and the negative electrode current collector due to volume expansion of graphite. As a result, it becomes easier for the negative electrode active material layer to separate from the negative electrode current collector.

When the negative electrode active material layer separates from the negative electrode current collector, the negative electrode current collector becomes exposed, and metallic lithium is deposited on this exposed portion. Thus, battery capacity and battery performance such as cycle characteristics degrades. Also, safety of the battery may become lower, since the separated piece of the negative electrode active material layer becomes a cause of internal short circuits.

PTL 1 discloses a negative electrode obtained by dry-mixing a carbon material and a binder, and then pressing a mixture thus obtained into pellet form, the binder comprising: a rubber-based high molecular compound whose degree of swelling relative to a non-aqueous electrolyte is low, such as styrene butadiene rubber and butadiene rubber; and cellulose ether whose degree of swelling relative to a non-aqueous electrolyte is high, such as Na salt of carboxymethyl cellulose and methyl hydroxyethyl cellulose.

PTL 2 discloses a negative electrode comprising an active material layer formed by applying to a current collector, a negative electrode material mixture slurry obtained by mixing graphite, a binder, a supplementary binder, and water, and then drying and rolling a coating film thus obtained, the binder being a carboxymethyl cellulose and the supplementary binder being a water-soluble high molecular compound such as hydroxypropyl methyl cellulose and hydroxyethyl methyl cellulose.

Separation of a negative electrode active material layer from a current collector would not be sufficiently suppressed, only by using a negative electrode material mixture slurry prepared by merely dry-mixing or wet-mixing a negative electrode active material and two different kinds of binders, as in PTLs 1 and 2.

PTL 3 discloses a method of heat-treating in a non-oxidizing atmosphere of 150° C. to 350° C., a negative electrode comprising an active material layer formed by applying to a current collector, a negative electrode material mixture slurry obtained by mixing: graphite; a binder that does not thermally decompose at 150° C. or lower in a non-oxidizing atmosphere, such as styrene butadiene rubber; and an aqueous solution of a thickener such as carboxymethyl cellulose, and then drying and rolling a coating film thus obtained.

### CITATION LIST

### Patent Literatures

[PTL 1] Japanese Laid-Open Patent Publication No. Hei 7-335221
[PTL 2] Japanese Laid-Open Patent Publication No. 2001-023642
[PTL 3] Japanese Laid-Open Patent Publication No. Hei 8-329946

### SUMMARY OF INVENTION

### Technical Problem

According to PTL 3, heating the negative electrode in a non-oxidizing atmosphere of 150 to 350° C. partially removes the binder and thickener covering the negative electrode active material in the negative electrode active material layer, and increases the speed at which lithium ions are absorbed by the negative electrode during charge. As a result, deposition of metallic lithium on the surface of the negative electrode active material layer, and growth of dendrites are suppressed. However, in PTL 3 also, a negative electrode material mixture slurry prepared by merely wet-mixing a negative electrode active material, a binder, and a thickener is used, and therefore, separation of the negative electrode active material layer from the current collector cannot be sufficiently suppressed even by heating the negative electrode.

An object of the present invention is to provide a non-aqueous electrolyte secondary battery comprising a negative electrode in which separation of a negative electrode active material layer from a negative electrode current collector is suppressed and having excellent battery capacity and excellent battery performance such as cycle characteristics.

### Solution to Problem

A negative electrode for a non-aqueous electrolyte secondary battery of the present invention comprises a negative electrode current collector and a negative electrode active material layer supported on the surface of the negative electrode current collector, and is such used in a non-aqueous electrolyte secondary battery including a non-aqueous electrolyte serving as an ion conductor. The negative electrode active material layer comprises (1) a negative electrode active material which expands and contracts by absorbing and desorbing lithium ions, (2) a rubber binder whose thermal decomposition temperature is equal to or higher than the softening temperature of the negative electrode current collector, (3) a water-soluble high molecular compound A whose thermal decomposition temperature is equal to or higher than the softening temperature of the negative electrode current collector, and (4) a water-soluble high molecular compound B whose thermal decomposition temperature is equal to or higher than the softening temperature of the negative electrode current collector and whose degree of swelling relative to the non-aqueous electrolyte is lower than that of the water-soluble high molecular compound A; the negative electrode active material have on a surface, a coating layer comprising the water-soluble high molecular compound A; and the tensile strength of the negative electrode is 15 N/cm or lower when the percentage elongation is 1% in the longitudinal direction.

A method for producing a negative electrode for a non-aqueous electrode secondary battery of the present invention is for a negative electrode which comprises a negative electrode current collector and a negative electrode active material layer supported on the surface of the negative electrode current collector, and which is used in a non-aqueous electrolyte secondary battery including a non-aqueous electrolyte serving as an ion conductor. The method comprises the following four steps. In the first step, a surface of a negative electrode active material, which expands and contracts by absorbing and desorbing lithium ions, is covered with a water-soluble high molecular compound A whose thermal decomposition temperature is equal to or higher than the softening temperature of the negative electrode current collector, thereby obtaining a negative electrode active material having a coating layer. In the next step, the negative electrode active material having a coating layer; a rubber binder whose thermal decomposition temperature is equal to or higher than the softening temperature of the negative electrode current collector; and a water-soluble high molecular compound B whose thermal decomposition temperature is equal to or higher than the softening temperature of the negative electrode current collector and whose degree of swelling relative to the non-aqueous electrolyte is lower than that of the water-soluble high molecular compound A; are mixed together with a dispersant, thereby preparing a negative electrode material mixture slurry. In the next step, the negative electrode material mixture slurry is applied to the surface of the negative electrode current collector, and a coating film thus obtained is dried and rolled, thereby obtaining a negative electrode precursor. In the final step, the negative electrode precursor is heated at a temperature equal to or higher than the softening temperature of the negative electrode current collector, thereby obtaining a negative electrode whose tensile strength is 15 N/cm or lower when the percentage elongation is 1% in the longitudinal direction.

A non-aqueous electrolyte secondary battery of the present invention comprises: a positive electrode which absorbs and desorbs lithium ions; a negative electrode which absorbs and desorbs lithium ions; a separator interposed between the positive electrode and the negative electrode; and a non-aqueous electrolyte, in which the negative electrode is the negative electrode described above.

### Advantageous Effects of Invention

The negative electrode of the present invention used in a non-aqueous electrolyte secondary battery enables suppression of separation of the negative electrode active material layer from the negative electrode current collector and suppression of deposition of metallic lithium on the negative electrode current collector surface, even when charge and discharge are repeated. By using this negative electrode, the non-aqueous electrolyte secondary battery of the present invention in which battery capacity and battery performance are maintained at high levels even when charge and discharge are repeated, and further, in which battery swelling rarely occurs, is provided.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A perspective view schematically illustrating the constitution of a non-aqueous electrolyte secondary battery which is the first embodiment of the present invention.

### DESCRIPTION OF EMBODIMENT

The present inventors, in their study for improving the overall battery performance of a non-aqueous electrolyte secondary battery, conceived the idea of allowing the surface of an active material to be covered with a water-soluble high molecular compound A whose degree of swelling relative to a non-aqueous electrolyte (hereinafter sometimes simply referred to as “degree of swelling”) is relatively high, so as to improve lithium ion conductivity among the active material in an active material layer. Also, when an active material layer was formed with use of a negative electrode material mixture slurry prepared by mixing together with a dispersant: an active material whose a surface is covered with a water-soluble high molecular compound A; a rubber binder; and as a thickener, a water-soluble high molecular compound B whose degree of swelling is relatively low, an active material layer with a more enhanced binding strength than that of the conventional active material layer was unexpectedly obtained.

In the light of this result, the present inventors contemplated that further enhancement of the binding strength of the negative electrode active material layer by using the above technique, may suppress deformation of the negative electrode active material layer which is due to expansion and contraction of the negative electrode active material, and separation of the negative electrode active material layer from the current collector. Therefore, the present inventors studied a method for further enhancing the binding strength of the negative electrode active material layer, and found that it is further enhanced by heating the negative electrode without allowing decompositions of the rubber binder and the water-soluble polymers A and B to occur. Further, the heating not only caused the binding strength of the negative electrode active material layer to become further enhanced, but also unexpectedly caused the tensile strength of the negative electrode current collector to become slightly lower.

As a result of further studies based on these findings, the present inventors found that heating the negative electrode at a temperature equal to or higher than the softening temperature of the negative electrode current collector can moderately reduce the tensile strength of the negative electrode current collector, while also preventing the negative electrode from breaking during production of the electrodes. Further, the present inventors found that by using a rubber binder and water-soluble high molecular compounds A and B whose respective thermal decomposition temperatures are equal to or higher than the softening temperature of the negative electrode current collector, decompositions of the rubber binder and the water-soluble high molecular compounds A and B are suppressed, thereby enabling formation of a negative electrode active material layer having a higher binding strength.

The above resulted in obtaining a negative electrode whose tensile strength is 15 N/cm or lower when the percentage elongation is 1% in the longitudinal direction and in which separation of the active material layer from the current collector is suppressed sufficiently. Reduction in battery capacity and degradation of battery performance declined remarkably when this negative electrode was used. The reason for being able to achieve such an effect is not sufficiently clear at this point, but is assumed to be as follows. By heating the negative electrode at a temperature equal to or higher than the softening temperature of the current collector, the binding strength of the active material layer becomes higher while the tensile strength of the current collector becomes lower, and the difference in strength between the active material layer and the current collector becomes small. Thus, deformation occurs nearly uniformly in the negative electrode as a whole, and the current collector follows the deformation of the active material layer, thereby reducing the slip therebetween. As a result, separation of the active material layer from the current collector is suppressed. The binding strength of the active material layer and the tensile strength of the negative electrode will be described in a later paragraph.

Note that a negative electrode, in which separation of the active material layer from the current collector is suppressed sufficiently, cannot be obtained even when heating is conducted at a temperature equal to or higher than the softening temperature of the current collector, when using a negative electrode material mixture slurry prepared by merely mixing together with a dispersant, a negative electrode active material, a rubber binder, and water-soluble high molecular compounds A and B, without the surface of the negative electrode active material being covered with the water-soluble high molecular compound A. Also, when water is used as the dispersant, there is concern that the water-soluble high molecular compound A, covering the surface of the negative electrode active material, may dissolve in water; however, it has been observed by the present inventors that the coating layer comprising the water-soluble high molecular compound A is present on the surface of the negative electrode active material, even after the heating of the negative electrode. However, since the water-soluble high molecular compound A dissolves in water when the negative electrode material mixture slurry is stored for a long period of time, it is preferable to form the negative electrode active material layer immediately, when a negative electrode material mixture slurry is prepared.

In the following, the features of the present invention will be described in further detail.

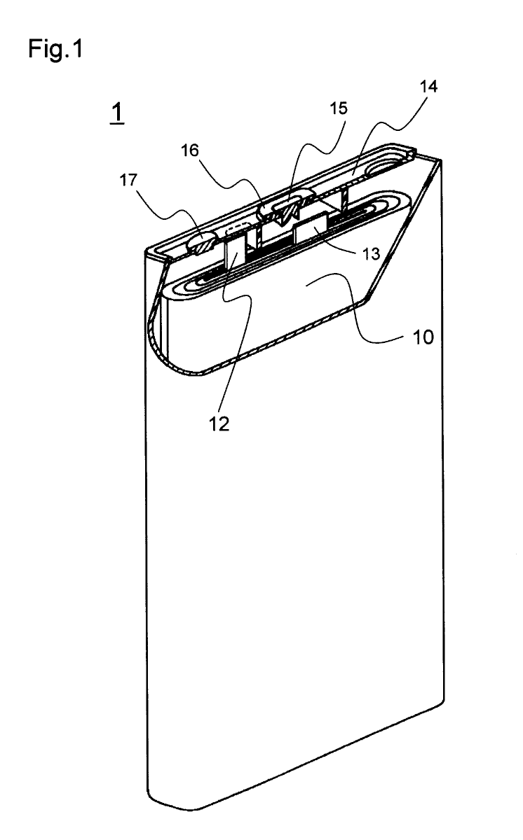

FIG. 1 is a perspective view schematically illustrating the constitution of a non-aqueous electrolyte secondary battery which is the first embodiment of the present invention. In FIG. 1, a notch is made in a part of the non-aqueous electrolyte secondary battery 1, so as to show the constitution of the main part thereof.

The non-aqueous electrode secondary battery 1 comprises: a flat electrode group 10 obtained by winding a positive electrode, a negative electrode, and a separator interposed therebetween, and forming the resultant to have a flat shape; a prismatic battery case 11 which houses therein the flat electrode group 10, anon-aqueous electrolyte (not illustrated), etc., and has an opening at one end in the longitudinal direction thereof; a sealing plate 14 which seals the opening of the prismatic battery case 11 and serves as a positive electrode terminal; a negative electrode terminal 15 supported on the sealing plate 14; a gasket 16 which insulates the sealing plate 14 from the negative electrode terminal 15; a positive electrode lead 12 which connects a positive electrode current collector and the sealing plate 14; a negative electrode lead 13 which connects a negative electrode current collector and the negative electrode terminal 15; and a sealing plug 17 which plugs an injection hole formed on the sealing plate 14, after injection of the non-aqueous electrolyte into the prismatic battery case 11.

The flat electrode group 10 can be fabricated by obtaining a wound-type electrode group by winding the positive electrode, the negative electrode, and the separator interposed therebetween, and then forming the resultant into a flat shape by press-forming or the like. The positive electrode, the negative electrode, and the separator are each in strip form. Note that the flat electrode group 10 can also be fabricated by winding around a rectangular plate, a stacked material in strip form comprising the positive electrode, the negative electrode, and the separator interposed therebetween.

The negative electrode of this embodiment can be produced by: preparing a negative electrode material mixture slurry by mixing together with a dispersant: each of the aforementioned ingredients of (1) to (4); applying the negative electrode material mixture slurry thus obtained to the surface of a negative electrode current collector; and drying and rolling a coating film thus obtained to form a negative electrode active material layer, thereby producing a negative electrode precursor; and then heating the negative electrode precursor thus obtained at a temperature equal to or higher than the softening temperature of the negative electrode current collector. The method for producing the negative electrode will be described in detail in a later paragraph. The negative electrode which is obtained in the above manner has a tensile strength of 15 N/cm or lower when the percentage elongation is 1% in the longitudinal direction. In the following, each component will be described in order.

The negative electrode current collector preferably has a softening temperature of 130 to 230° C., and more preferably, 170 to 230° C. If the softening temperature is too low, a problem may occur where, when the negative electrode material mixture paste is applied to the negative electrode current collector, the pressure due to the application causes the negative electrode current collector to elongate, thereby causing creases on the negative electrode active material layer and thus causing the negative electrode performance to degrade. Also, the negative electrode current collector may soften more than required, when the negative electrode precursor is heated. On the other hand, if the softening temperature is too high, reduction in tensile strength of the negative electrode current collector may become insufficient, even if heating is conducted after the negative electrode active material layer is formed on the negative electrode current collector surface. As a result, separation of the negative electrode active material layer from the negative electrode current collector may occur due to increase in the numbers of charge and discharge. To adjust the softening temperature of the negative electrode current collector to be within the aforementioned range, at least one of the material, thickness, form, etc. of the negative electrode current collector may be selected as appropriate.

Examples of the material for the negative electrode current collector include metallic materials such as stainless steel, nickel, copper, a copper alloy, and the like. Among these metallic materials, from the aspect of adjusting the softening temperature to be within the aforementioned range, preferable are copper and a copper alloy, more preferable is copper of high purity, and further preferable is tough pitch copper of high purity. The softening temperature of copper is 180° C. to 200° C.

The thickness of the negative electrode current collector is preferably 1 μm to 50 μm, and more preferably 5 μm to 10 μm. 5 μm to 10 μm being the more preferable range is thinner than the thickness of the negative electrode current collector by the conventional technique. If the thickness is selected from the aforementioned range, greater flexibility would be allowed in selecting the material, when adjusting the softening temperature of the negative electrode current collector to be within the aforementioned range. In addition to the above, the weight of the negative electrode can be reduced and the thickness thereof can be made thinner, while maintaining the tensile strength thereof to be 15 N/cm or lower.

The negative electrode current collector is in the form of metal foil, a porous metal sheet, or the like. The softening temperature of metal foil can be adjusted by selecting at least one of the material and thickness thereof. A porous metal sheet can be in various forms such as a mesh, a net, a punched sheet, a lath, a porous matter, a foam, a woven fabric, and a non-woven fabric. The softening temperature of a porous metal sheet can be adjusted by selecting at least one of the material, thickness, and form thereof.

In the present specification, the softening temperature of the negative electrode current collector was determined in the following manner. The negative electrode current collector, having a width of 15 mm and a valid portion length of 20 mm, was heated in a nitrogen atmosphere at any temperature for 10 hours. The breaking strength of the resultant negative electrode current collector when pulled by a tensile strength tester at a speed of 20 mm/min was measured, the start of softening was determined by the measured value thus obtained, and the heating temperature at which the measured value was obtained was designated as the softening temperature of the negative electrode current collector. Note that the valid portion length means the length of the part of the negative electrode current collector which is not clamped between fixing members of a tensile strength tester, when each end of the negative electrode current collector in the longitudinal direction is clamped and fixed by such fixing members.

The negative electrode active material layer supported on the surface of the negative electrode current collector comprises: (1) a negative electrode active material which expands and contracts by absorbing and desorbing lithium ions; (2) a rubber binder whose thermal decomposition temperature is equal to or higher than the softening temperature of the negative electrode current collector; (3) a water-soluble high molecular compound A whose thermal decomposition temperature is equal to or higher than the softening temperature of the negative electrode current collector; and (4) a water-soluble high molecular compound B whose thermal decomposition temperature is equal to or higher than the softening temperature of the negative electrode current collector and whose degree of swelling is lower than that of the water-soluble high molecular compound A, the negative electrode active material having on the surface, a coating layer comprising the water-soluble high molecular compound A. The negative electrode active material layer of this embodiment is formed on both surfaces of the negative electrode current collector, but may be formed only on one surface thereof.

### (1) Negative Electrode Active Material

Used as the negative electrode active material, is a negative electrode active material in the form of particles which expands and contracts by absorbing (charging) and desorbing (discharging) lithium ions. Examples of such negative electrode active materials include carbon materials, alloyable active materials, and the like. Among the above, carbon materials are more preferable from the aspect of making the behavior of the negative electrode as a whole, as uniform as possible.

Examples of carbon materials include natural graphite, artificial graphite, coke, partially graphitized carbon, carbon fiber, spherical carbon, amorphous carbon and the like. Among these carbon materials, natural graphite and artificial graphite are preferable. Examples of alloyable active materials include: silicon, silicon oxides represented by a formula: SiOₐ (0.05<a<1.95), silicon nitrides represented by a formula: SiN_{b} (0<b<4/3), silicon alloys, tin, tin oxides represented by a formula: SnO_{d} (0<d≦2), and tin alloys. Among these alloyable active materials, silicon and silicon oxides are preferable. These negative electrode active materials can be used singly or in combination.

### (2) Rubber Binder

The rubber binder is used, for example, to give elasticity to the negative electrode active material layer and to lessen volume change (expansion and contraction) of the negative electrode active material. As the rubber binder, a rubber binder whose thermal decomposition temperature is equal to or higher than the softening temperature of the negative electrode current collector is used. In the present specification, a thermal decomposition temperature is a temperature at which the peak of heat generation caused by thermal decomposition is observed by differential scanning calorimetry.

If a rubber binder whose thermal decomposition temperature is lower than the softening temperature of the negative electrode current collector is used, the rubber binder decomposes due to heating conducted after the negative electrode active material layer is formed, and the lessening of volume change in the negative electrode active material, enabled by the rubber binder, may become insufficient. Also, the ability of the negative electrode current collector to follow the negative electrode active material layer may become lower, regardless of the increased binding strength of the negative electrode active material layer and the moderately decreased tensile strength of the negative electrode current collector. As a result, the negative electrode active material layer may separate from the negative electrode current collector.

The rubber binder is not particularly limited as long as it is a rubber whose thermal decomposition temperature is equal to or higher than the softening temperature of the negative electrode current collector, and examples include styrene-butadiene rubber, high-styrene rubber, ethylene-propylene rubber, butyl rubber, chloroprene rubber, butadiene rubber, isoprene rubber, acrylonitrile-butadiene rubber, acrylonitrile rubber, fluoro rubber, acrylic rubber, and silicone rubber. Among the aforementioned kinds of rubbers, the thermal decomposition temperature of the copolymer rubbers can be adjusted by selecting the ratio of the copolymer components, degree of polymerization, etc. thereof. Also, the thermal decomposition temperature of the rubbers in which a single component is polymerized can be adjusted by selecting the degree of polymerization, etc. thereof. These rubber binders can be used singly or in combination.

The rubber binder is preferably used in the form of particles. The average volume-based particle size of the rubber binder particles is not particularly limited, but is preferably 0.1 μm to 2 μm, and more preferably 0.1 μm to 0.3 μm. By using the rubber binder particles having an average volume-based particle size within the aforementioned range, dispersibility of the rubber binder particles in the negative electrode active material layer is enhanced, thereby making greater the effect caused due to adding the rubber binder. As a result, expansion of the negative electrode active material layer during charge is moderately lessened, and the ability of the negative electrode current collector to follow the negative electrode active material layer is relatively enhanced.

In the present specification, the average volume-based particle size is the value measured with a particle size distribution measuring apparatus (trade name: Multisizer 3, available from Beckman Coulter, Inc.). In the present specification, the average volume-based particle size is a particle size D50V which represents a cumulative volume of 50% from the side of the large particle size, in cumulative volume distribution. The measurement conditions are as follows.

### (Measurement Conditions)

Aperture size: 20 μm

Number of target particles: 50,000 counts

Analysis software: Coulter Multisizer AccuComp, version 1.19 (available from Beckman Coulter, Inc.)

Electrolyte solution: ISOTON-II (available from Beckman Coulter, Inc.)

Dispersant: sodium alkyl ether sulfate

A sample is prepared, by adding into a beaker 50 ml of the electrolyte solution, 20 mg of the particles whose average volume-based particle size is to be measured, and 1 ml of the dispersant, and then subjecting the resultant to dispersion at an ultrasonic frequency of 20 kHz for 3 minutes, with a ultrasonic disperser (trade name: UH-50, available from SMT Co., Ltd.). With use of this sample, measurement of particle size is conducted with a particle size distribution measuring apparatus (Multisizer 3). From the obtained result, volume-based particle size distribution is obtained, from which the average volume-based particle size (D50V) is calculated.

The content of the rubber binder in the negative electrode active material layer is not particularly limited, but is preferably 0.3 to 3 parts by mass and more preferably 0.5 to 1 part by mass, relative to 100 parts by mass of the negative electrode active material. If the content of the rubber binder is too small, the effect due to adding the rubber binder becomes insufficient, and the negative electrode active material layer may separate from the negative electrode current collector. On the other hand, if the content of the rubber binder is too large, the amount of the negative electrode active material relatively decreases, and there may be reduction in the battery capacity of the non-aqueous electrolyte secondary battery 1.

### (3) Water-Soluble High Molecular Compound A

The water-soluble high molecular compound A has a thermal decomposition temperature equal to or higher than the softening temperature of the negative electrode current collector. Thus, thermal decomposition of the water-soluble high molecular compound A is suppressed during heating of the negative electrode precursor. With respect to the water-soluble high molecular compound A, the degree of swelling relative to the non-aqueous electrolyte is preferably 10% or higher, and more preferably within the range of 10% to 15%. Herein, the non-aqueous electrolyte is such used in a non-aqueous electrolyte secondary battery comprising the negative electrode of this embodiment. If the degree of swelling of the water-soluble high molecular compound A is too low, the lithium ion conductivity and binding strength of the negative electrode active material layer may become lower. The degree of swelling of the water-soluble high molecular compound A can be adjusted by selecting the degree of polymerization or molecular weight thereof.

In the present specification, degree of swelling is measured in the following manner. A sheet having a thickness of 1 mm is made by allowing a water-soluble high molecular compound to dissolve in water, thereby preparing an aqueous solution; applying this aqueous solution to a flat glass surface; and then drying a coating film thus obtained. This sheet is cut to a size of 20 mm×20 mm, thereby forming a sample. In an airtight container, the sample is immersed in a non-aqueous electrolyte at 25° C. for 24 hours. Then, by using the following equation, the degree of swelling is obtained as the percentage by which the mass of the sample after immersion in the non-aqueous electrolyte (Y) increases, relative to the mass of the sample before immersion therein (X).

Degree of swelling(%)={(Y−X)/X}×100

In addition, with respect to the water-soluble high molecular compound A, the viscosity (25° C.) of a 1 mass % aqueous solution is preferably 50 mPa·s to 2,000 mPa·s, and more preferably 500 mPa·s to 1,000 mPa·s. The viscosity is the value measured at a circumferential velocity of 20 mm/s, with use of a type B viscometer and a 5 mmφ spindle. In the present specification, a water-soluble high molecular compound is such including a plurality of the same polymeric unit and which completely dissolves when 10 g thereof is mixed with 1,000 g of water (liquid temperature: 25° C.)

Polymer compounds such as polyvinyl alcohol, polyvinylpyrrolidone, polyethylene oxide, and derivatives thereof, and polysaccharide compounds such as cellulose and carboxymethyl cellulose, can be used as the water-soluble high molecular compound A. Among the above, polymer compounds are preferable, and polyvinyl alcohol and polyethylene oxide are more preferable. The respective thermal decomposition temperatures of a polymer compound and a polysaccharide compound can be adjusted by selecting, for example, the degree of polymerization or molecular weight thereof.

In present invention, a coating layer comprising the water-soluble high molecular compound A is formed on at least a part of the surface of the negative electrode active material. This coating layer enhances adhesion among the negative electrode active material in the negative electrode active material layer and enhances adhesion between the negative electrode active material layer and the negative electrode current collector. Also, it becomes easier for the negative electrode current collector to follow the expansion of the negative electrode active material layer, since the fact that the negative electrode active material layer comprises the negative electrode active material covered with the water-soluble high molecular compound A enables smaller variation in the binding strength of the negative electrode active material layer as a whole, thereby making it difficult for a large expansion to occur locally in the negative electrode active material layer during charge. As a result, separation of the negative electrode active material layer from the negative electrode current collector becomes unlikely to occur, even when there is an increase in the numbers of charge and discharge. Note that this coating layer also rarely interrupts lithium ions from passing through and rarely increases in electrical resistance.

The content of the water-soluble high molecular compound A in the negative electrode active material layer is preferably 0.5 to 2.5 parts by mass, more preferably 0.5 to 1.5 parts by mass, and further preferably 0.5 to 1 part by mass, relative to 100 parts by mass of the negative electrode active material. If the content of the water-soluble high molecular compound A is within the aforementioned range, the surface of the negative electrode active material can be covered nearly uniformly. In addition, rise of internal resistance in the negative electrode can be suppressed, since the surface of the negative electrode active material would not be excessively covered with the water-soluble high molecular compound A.

If the content of the water-soluble high molecular compound A is too small, the surface of the negative electrode active material may be insufficiently covered with the water-soluble high molecular compound A. Due to the above, effects such as enhanced adhesion between the negative electrode active material layer and the negative electrode current collector and lessened variation in the binding strength of the negative electrode active material layer, may become insufficient. If the content of the water-soluble high molecular compound A is too large, the surface of the negative electrode active material may be excessively covered with the water-soluble high molecular compound A, thereby causing rise in the internal resistance in the negative electrode.

### (4) Water-Soluble High Molecular Compound B

The water-soluble high molecular compound B has various functions. First, it functions as a thickener. That is, the water-soluble high molecular compound B provides moderate viscosity to the negative electrode material mixture slurry, and enhances the coating properties of the negative electrode material mixture slurry toward the negative electrode current collector. Also, the water-soluble high molecular compound B suppresses the dissolving of the water-soluble high molecular compound A, attached to the surface of the negative electrode active material, in water. Further, the water-soluble high molecular compound B remains in the negative electrode active material layer after the heating of the negative electrode precursor and supports the function of the water-soluble high molecular compound A.

The water-soluble high molecular compound B is a water-soluble high molecular compound having a thermal decomposition temperature equal to or higher than the softening temperature of the negative electrode current collector and a degree of swelling lower than that of the water-soluble high molecular compound A. When the thermal decomposition temperature of the water-soluble high molecular compound B is lower than the softening temperature of the negative electrode current collector, the water-soluble high molecular compound B decomposes due to the heating of the negative electrode precursor, and its function of supporting the water-soluble high molecular compound A is lost.

The degree of swelling of the water-soluble high molecular compound B is measured in the same manner as that for the water-soluble high molecular compound A, and is preferably lower than 10%, and more preferably 5% or higher and lower than 10%. If the degree of swelling of the water-soluble high molecular compound B is too high, the dispersibilities of the ingredients (1) and (3) in the negative electrode material mixture slurry would become lower, and the negative electrode active material layer with small variation in binding strength may not be obtained. The degree of swelling of the water-soluble high molecular compound B can be adjusted by selecting the degree of polymerization or molecular weight thereof.

With respect to the water-soluble high molecular compound B, the viscosity (25° C.) of a 1 mass % aqueous solution is preferably 1,500 mPa·s to 10,000 mPa·s, and more preferably 4,000 mPa·s to 7,000 mPa·s. The viscosity is the value measured at a circumferential velocity of 20 mm/s, with use of a type B viscometer and a 5 mmφ spindle.

Polysaccharide compounds such as methyl cellulose, carboxymethyl cellulose, Na salt of carboxymethyl cellulose, and derivatives thereof can be used as the water-soluble high molecular compound B. The thermal decomposition temperature of a polysaccharide compound can be adjusted by selecting as appropriate, the degree of polymerization or molecular weight of the saccharide compound, the substituent group bonded to a side chain, or the like. Note that when a polysaccharide compound is used as the water-soluble high molecular compound A, a different polysaccharide compound may be used as the water-soluble high molecular compound B.

The content of the water-soluble high molecular compound B in the negative electrode active material layer is preferably 0.5 to 2 parts by mass and more preferably 0.7 to 1.3 parts by mass, relative to 100 parts by mass of the negative electrode active material. If the content of the water-soluble high molecular compound B is too small, the coating properties of the negative electrode material mixture slurry may degrade. If the content of the water-soluble high molecular compound B is too large, the viscosity of the negative electrode material mixture slurry becomes higher, the dispersibility of the negative electrode active material having the coating layer on the surface and the rubber binder become lower, and the negative electrode active material layer having the desired binding strength may not be formed.

The negative electrode active material layer may include, in addition to the aforementioned ingredients of (1) to (4), a conductive agent, a binder, etc. which are conventionally used in a negative electrode for a non-aqueous electrolyte secondary battery, as long as favorable properties of the negative electrode of this embodiment are not lost. As the conductive agent and the binder, a conductive agent and binder included in the positive electrode active material layer, both which will be described in a later paragraph, can be used.

With respect to the negative electrode active material layer, the binding strength is preferably 10 N or higher, and more preferably 10 N to 30 N. This further enhances in adhesion between the negative electrode active material layer and the negative electrode current collector. Also, there are smaller variation in the binding strength in the negative electrode active material layer as a whole; suppression of large expansion occurring locally in a part of the negative electrode active material layer during charge; and further enhancement in the ability of the negative electrode current collector to follow the expansion of the negative electrode active material layer. As a result, even if there is an increase in the numbers of charge and discharge, there would be a more remarkable suppression of separation of the negative electrode active material layer from the negative electrode current collector. To make the binding strength of the negative electrode active material layer be 10 N or higher, a selection may be made as appropriate among: the kind and coating amount of the water-soluble high molecular compound A with which the surface of the negative electrode active material is covered; the material, thickness, and form of the negative electrode current collector; the heating temperature for the negative electrode precursor; and the like.

The binding strength of the negative electrode active material layer is nearly the same as the binding strength among the negative electrode active material in the negative electrode active material layer. In the present specification, the binding strength of the negative electrode active material layer is measured in the following manner.

### [Method for Measuring Binding Strength of Negative Electrode Active Material Layer]

First, a negative electrode piece of 2 cm×3 cm is obtained by cutting the negative electrode having the negative electrode active material layer on both surfaces of the current collector in the thickness direction thereof. The negative electrode active material layer on one surface of the negative electrode piece thus obtained is peeled off, and the negative electrode active material layer on the other surface thereof remains as it is. This negative electrode piece is attached to a double-sided adhesive tape (product number: No. 515, available from Nitto Denko Corporation) which is attached onto a glass plate, so as to create adhesion between the negative electrode active material layer on the other surface thereof and the adhesive layer of the double-sided adhesion tape.

Next, the negative electrode current collector is separated from the negative electrode piece, thereby exposing the negative electrode active material layer. This results in obtaining a measurement sample, in which the negative electrode active material layer is attached to one side of the double-sided adhesive tape. A peel test is conducted, by: attaching to the tip of the measuring probe (tip diameter: 0.2 cm, cross-sectional area: 0.031 cm²) of a tack tester (trade name: TAC-II, available from Rhesca Corporation), the side of the double-sided adhesive tape on the above measurement sample to which the negative electrode active material layer is not attached; pressing the probe onto the negative electrode active material layer under the test conditions as below; and then pulling away the probe. In this peel test, the maximum load at which separation occurs in the negative electrode active material layer is measured. The value obtained by dividing the maximum load thus obtained by the cross-sectional area of the measuring probe is designated as the binding strength (N) of the negative electrode active material layer.

### (Test Conditions)

Pressing speed of probe: 30 mm/min

Pressing time of probe: 10 seconds

Pressing load of probe: 3.92 N (0.4 kgf)

Separating speed of probe: 600 mm/min

With respect to the negative electrode of this embodiment, the tensile strength when the percentage elongation is 1% in the longitudinal direction (hereinafter simply referred to as “tensile strength of the negative electrode”) is preferably 15 N/cm or lower and more preferably 10 N/cm or lower. Herein, the longitudinal direction means the longitudinal direction of the negative electrode in strip form. If the tensile strength of the negative electrode exceeds 15 N/cm, the negative electrode current collector may not be able to sufficiently follow the volume change of the negative electrode active material layer. As a result, with the increase in the numbers of charge and discharge, separation of the negative electrode active material layer from the negative electrode current collector and deposition of metallic lithium on the negative electrode current collector, may easily occur.

Note that the lower limit of the tensile strength of the negative electrode is determined as appropriate, depending on the product conditions, etc. of the negative electrode during its mass production. For example, during fabrication of the wound-type electrode group, the lower limit of the tensile strength of the negative electrode is set to a value at which the negative electrode does not break due to the tension applied to the electrode stack comprising the positive electrode, the negative electrode, and the separator interposed therebetween. For example, the lower limit is set to 5 N/cm.

In the present specification, the tensile strength of the negative electrode is measured in the following manner. First, a non-aqueous electrode secondary battery is assembled and charged until 4.2 V at initial charge. Thereafter, the non-aqueous electrolyte secondary battery is disassembled, and the negative electrode is taken out and cut to produce a test piece 15 mm in width and 20 mm in length. At this time, the test piece is produced in a manner such that the longitudinal direction thereof is the same as the longitudinal direction of the negative electrode. One end of the test piece in the longitudinal direction thereof is fixed to a tensile tester (trade name: TENSILON Universal Material Testing Instrument RTC-1210, available from A&D Company, Ltd.), and the other end thereof is pulled in the aforementioned longitudinal direction while adjusting the tensile force, so that the test piece stretches at a speed of 1 mm/min. The tensile strength of the test piece when the percentage elongation reaches 1% is designated as the tensile strength of the negative electrode.

The percentage elongation of the test piece can be obtained by an equation: {(y−x)/x}×100, when the length of the test piece before pulling is designated as x and the length of the test piece after pulling is designated as y.

Note that during disassembling of the non-aqueous electrolyte secondary battery 1, the negative electrode may be in a state where the negative electrode active material layer is partly or mostly separated from the negative electrode current collector. However, the tensile strength of the negative electrode is nearly the same as that of the negative electrode current collector. Therefore, the tensile strength can be measured by using the negative electrode in the aforementioned state, and if the measured value is within the aforementioned range, the negative electrode can be determined as such having the desired effect.

Next, the method for producing the negative electrode of this will be described in detail. The method for producing the negative electrode of this embodiment comprises the steps of: allowing a surface of a negative electrode active material to be covered with a water-soluble high molecular compound A; preparing a negative electrode material mixture slurry; producing a negative electrode precursor; and heating the negative electrode precursor, thereby producing the negative electrode of this embodiment.

In the first step, the negative electrode active material having on the surface a coating layer comprising the water-soluble high molecular compound A is produced, for example, by mixing an aqueous solution of the water-soluble high molecular compound A together with a negative electrode active material, and then drying the resultant mixture.

With respect to the aqueous solution of the water-soluble high molecular compound A, the viscosity at 25° C. is preferably 1,500 mPa·s to 10,000 mPa·s. The viscosity is the value measured at a circumferential velocity of 20 mm/s, with use of a type B viscometer and a 5 mm φ spindle. The viscosity being within the aforementioned range enables smaller variation in the thickness of the coating layer including the water-soluble high molecular compound A, which is formed on the surface of the negative electrode active material. Further, in the next step following this step, redissolution in water, of the water-soluble high molecular compound A attached to the surface of the negative electrode active material, is suppressed.

The mixing ratio between the aqueous solution of the water-soluble high molecular compound A and the negative electrode active material is not particularly limited, but to give an example, 5 to 20 parts by mass of an aqueous solution, in which 0.3 to 10 parts by mass of the water-soluble high molecular compound A is dissolved, relative to 100 parts by mass of the negative electrode active material, is used. At this time, it is preferable that the concentration of the water-soluble high molecular compound A in the aqueous solution is adjusted, in a manner such that the content of the water-soluble high molecular compound A in the negative electrode active material layer after the final step would be 0.5 to 2.5 parts by mass relative to 100 parts by mass of the negative electrode active material; and the viscosity of the aqueous solution would be within the aforementioned range.

In the next step, the negative electrode material mixture slurry is prepared by mixing together with a dispersant: the negative electrode active material having on the surface the coating layer comprising the water-soluble high molecular compound A, obtained in the previous step; a rubber binder; and a water-soluble high molecular compound B. The amount of the rubber binder used is preferably adjusted, in a manner such that the content of the rubber binder in the negative electrode active material layer after the final step would be 0.3 to 3.0 parts by mass relative to 100 parts by mass of the negative electrode active material. With consideration to the coating properties of the negative electrode material mixture slurry, the respective amounts of the water-soluble high molecular compound B and the dispersant used are preferably selected, in a manner such that the viscosity of the negative electrode material mixture slurry would be 5,000 cP to 20,000 cP (25° C.) Water is preferably used as the dispersant, but an organic solvent may be used as well.

Further, in the next step, the negative electrode precursor is produced by applying the negative electrode material mixture slurry obtained in the previous step to the surface of the negative electrode current collector, and then drying and rolling a coating film thus obtained, thereby forming a negative electrode active material layer. The thickness of the negative electrode active material layer is not particularly limited, but is preferably 120 μm to 300 μm. In this embodiment, the negative electrode material mixture slurry is applied to both surfaces of the negative electrode current collector in the thickness direction thereof. The method for the application is not particularly limited, and known coating methods such as reverse roll coating, direct roll coating, blade coating, knife coating, extrusion coating, curtain coating, gravure roll coating, bar coating, cast coating, dip coating, and squeeze coating can be utilized.

In the final step, the negative electrode precursor obtained in the previous step is heated at a temperature equal to or higher than the softening temperature of the negative electrode current collector, thereby obtaining the negative electrode of this embodiment whose tensile strength is 15 N/cm or lower. If the heating temperature for the negative electrode precursor is lower than the softening temperature of the negative electrode current collector, the negative electrode of this embodiment whose tensile strength is 15 N/cm or lower may not be obtained. This step is preferably carried out in vacuum or a non-oxidizing atmosphere, so as to prevent the negative electrode current collector from being oxidized. Examples of a non-oxidizing atmosphere include nitrogen gas, argon gas, and carbon dioxide gas.

Note that the upper limit of the heating temperature for the negative electrode precursor may be set lower than the thermal decomposition temperature of the ingredient having the lowest thermal decomposition temperature among the rubber binder and the water-soluble high molecular compounds A and B. In the alternative, when the thermal decomposition temperature of the ingredient having the lowest thermal decomposition temperature is higher than 230° C., the upper limit is preferably set to 230° C. or lower. This is because the effect in which the tensile strength of the negative electrode becomes lower when the negative electrode precursor is heated at a temperature exceeding 230° C., does not change much compared to when it is heated at 230° C. or lower. Therefore, to avoid unnecessary energy consumption, the heating temperature is preferably set to 230° C. or lower.

For example, when the negative electrode current collector is copper foil whose softening temperature is 180° C. to 200° C., and the thermal decomposition temperature of the ingredient having the lowest thermal decomposition temperature among the rubber binder and the water-soluble polymers A and B is lower than 230° C., the heating temperature is preferably selected from the range of such equal to or higher than the softening temperature of this copper foil, and the range of such lower than the thermal decomposition temperature of the ingredient having the lowest thermal decomposition temperature. When the negative electrode current collector is copper foil whose softening temperature is 180° C. to 200° C., and the respective temperatures of the rubber binder and the water-soluble high molecular compounds A and B exceed 230° C., the heating temperature is preferably selected from the range of such equal to or higher than the softening temperature of this copper foil, and the range of such equal to or lower than 230° C. The heating time is preferably 30 minutes to 24 hours, and more preferably 5 hours to 10 hours.

Next, components in the non-aqueous electrode secondary battery 1, other than the negative electrode, will be described.

The positive electrode comprises a positive electrode current collector and a positive electrode active material layer.

As the positive electrode current collector, a porous metal sheet or metal foil made of stainless steel, aluminum, an aluminum alloy, titanium, or the like can be used. Examples of a porous metallic sheet include a woven fabric, a non-woven fabric, a perforated sheet, and the like. The thickness of the positive electrode current collector is preferably 1 μm to 100 μm and more preferably 5 μm to 50 μm.

In this embodiment, the positive electrode active material layer is formed on both surfaces of the positive electrode current collector in the thickness direction thereof, but is not limited thereto, and may be formed only on one surface thereof. The positive electrode active material layer includes a positive electrode active material, a conductive agent, and a binder.

As the positive electrode active material, known positive electrode active materials for a non-aqueous electrolyte secondary battery can be used, and among them, lithium-containing composite oxides, olivine-type lithium phosphates, and the like are preferable, particularly preferable being lithium-containing composite oxides.

Lithium-containing composite oxide are metal oxides containing lithium and transition metal elements, or such metal oxides in which part of the transition metal element (s) is replaced with different element(s). Examples of transition metal elements include Sc, Y, Mn, Fe, Co, Ni, Cu, and Cr. Among these transition metal elements, Mn, Co, and Ni are preferable. Examples of different elements include Na, Mg, Zn, Al, Pb, Sb, and B. Among these different elements, Mg and Al are preferable. These transition metal elements may be used singly or in combination. These different elements may be used singly or in combination.

Specific examples of lithium-containing composite oxides include: LiₓCoO₂, LiₓNiO₂, LiₓMnO₂, LiₓCoₘNi₁₋ₘO₂, LiₓCoₘM₁₋ₘOₙ, LiₓNi₁₋ₘMₘOₙ, LiₓMn₂O₄, and LiₓMn₂₋ₘMnO₄ (wherein M represents at least one element selected from the group consisting of Sc, Y, Mn, Fe, Co, Ni, Cu, Cr, Na, Mg, Zn, Al, Pb, Sb, and B; 0<x≦1.2, m=0 to 0.9, and n=2.0 to 2.3). Among these lithium-containing composite oxides, LiₓCoₘM₁₋ₘOₙ is preferable.

Examples of olivine-type lithium phosphates include LiAPO₄ and Li₂APO₄F (wherein A represents at least one element selected from the group consisting of Co, Ni, Mn, and Fe).

In the above-listed compositional formulas, the molar ratio of lithium is the value immediately after synthesis of the positive electrode active material, and increases and decreases by discharge and charge. These positive electrode active materials can be used singly or in combination.

Examples of conductive agents include: graphites such as natural graphite and artificial graphite; carbon blacks such as acetylene black, ketjen black, channel black, furnace black, lamp black, and thermal black; conductive fibers such as carbon fiber and metallic fiber; metal powders such as that of aluminum; conductive metal oxides such as titanium oxide; and fluorinated carbon. These conductive agents can be used singly or in combination.

Examples of binders include: polyvinylidene fluoride, polytetrafluoroethylene, polyhexafluoropropylene, vinylidene fluoride-hexafluoropropylene copolymer, polyethylene, polypropylene, polyamide, polyimide, polyamide-imide, polyacrylonitrile, polyacrylic acid, methyl polyacrylate, ethyl polyacrylate, hexyl polyacrylate, polymethacrylic acid, methyl polymethacrylate, ethyl polymethacrylate, hexyl polymethacrylate, polyvinyl acetate, polyether, polyethersulfone, styrene-butadiene rubber, modified acrylic rubber, polyvinylpyrrolidone, and carboxymethyl cellulose. These binders can be used singly or in combination.

The positive electrode active material layer can be formed, for example, by applying a positive electrode material mixture slurry onto a surface of a positive electrode current collector, and then drying and rolling a coating film thus obtained. The positive electrode material mixture slurry can be prepared by mixing together with a dispersant, a positive electrode active material, a conductive agent, and a binder. Examples of the dispersant include: organic solvents such as dimethylformamide, dimethylacetamide, methylformamide, N-methyl-2-pyrrolidone, dimethylamine, acetone, and cyclohexanone; and water.

The separator is disposed so as to be interposed between the positive electrode and the negative electrode, insulates the positive electrode from the negative electrode, and allows permeability to lithium ions. As the separator, a porous sheet having pores therein, or a non-woven or woven fabric made of resin fiber can be used. The porous sheet and the resin fiber are made of a resin material. Examples of the resin materials include polyolefins such as polyethylene and polypropylene; polyamides; and polyamide-imides. Among these, the porous sheet is preferable. The pore size of the porous sheet is preferably 0.05 μm to 0.15 μm. The thickness of the porous sheet is preferably 5 μm to 40 μm.

The flat electrode group 10 is impregnated with the non-aqueous electrolyte. The non-aqueous electrolyte in this embodiment includes lithium salt and a non-aqueous solvent, and may further include an additive.

Examples of lithium salts include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, chloroborane lithium, borates, and imide salts. These lithium salts can be used singly or in combination. The concentration of lithium salt is preferably 0.5 mol to 2 mols relative to 1 liter of the non-aqueous solvent.

Examples of non-aqueous solvents include: cyclic carbonate esters such as propylene carbonate and ethylene carbonate; chain carbonate esters such as diethyl carbonate, ethyl methyl carbonate, and dimethyl carbonate; cyclic carboxylate esters such as γ-butyrolactone and γ-valerolactone, and the like. These non-aqueous solvents can be used singly or in combination.

Examples of additives include: vinylene carbonate compounds such as vinylene carbonate, vinylethylene carbonate, divinylethylene carbonate; and benzene compounds such as cyclohexylbenzene, biphenyl, and diphenyl ether.

An aluminum lead or the like can be used as a positive electrode lead 12. A nickel lead, a copper lead, or the like can be used as a negative electrode lead 13. A sealing plate 14 is produced, for example, by forming a metal material such as stainless steel and iron into a predetermined form. A negative electrode terminal 15 is produced, for example, by forming a metal material such as nickel, copper, and stainless steel into a predetermined form. A gasket 16 is produced, for example, by forming a resin material such as polypropylene into a predetermined form.

In this embodiment, a description is given on the non-aqueous electrolyte secondary battery 1 having a prismatic form. However, the non-aqueous electrolyte secondary battery of the present invention is not limited to a prismatic battery. The non-aqueous electrolyte secondary battery of the present invention can be a battery in various forms such as: a cylindrical battery comprising a wound-type electrode group; a battery comprising a wound-type electrode group, flat electrode group, or stacked-type electrode group housed in a battery case made of laminated film; and a coin-type battery comprising a stacked-type electrode group.

### EXAMPLES

In the following, examples and comparative examples will be given to describe the present invention in detail.

### Example 1

### (1) Production of Positive Electrode

A positive electrode material mixture slurry was prepared by mixing with a double-arm kneader, 100 parts by mass of LiNi_{0.82}Co_{0.15}Al_{0.03}O₂ (positive electrode active material), 1 part by mass of acetylene black (conductive agent), 1 part by mass of polyvinylidene fluoride (binder), and 25 parts by mass of N-methyl-2-pyrollidone. This positive electrode material mixture slurry was applied to both surfaces of a 15 μm-thick aluminum foil in strip form (positive electrode current collector, 35 mm×400 mm), a coating film thus obtained was dried and rolled, thereby producing a positive electrode. The total thickness of the positive electrode current collector and the positive electrode active material layer on both surfaces thereof, was 120 μm. Thereafter, the positive electrode was cut to a predetermined size, thereby obtaining a positive electrode plate in strip form.

### (2) Production of Negative Electrode

Scale-like artificial graphite was pulverized and sieved, and the average volume-based particle size was adjusted to 20 μm. The resultant was designated as a negative electrode active material. This negative electrode active material in an amount of 100 parts by mass was mixed with 20 parts by mass of a 3 mass % aqueous solution (viscosity at 25° C.: 5,000 cP) of polyvinyl alcohol (water-soluble high molecular compound A, thermal decomposition temperature: 230° C., degree of swelling: 12, viscosity of 1 mass % aqueous solution (25° C.): 1,000 mPa·s). A mixture thus obtained was dried at 110° C. for 30 minutes, thereby producing a negative electrode active material having on a surface, a coating layer including polyvinyl alcohol. In total, 0.5 part by mass of polyvinyl alcohol was attached to 100 parts by mass of the negative electrode active material.

A negative electrode material mixture slurry was prepared by mixing with a double-arm kneader: 100 parts by mass of the negative electrode active material obtained above; 1 part by mass of an aqueous dispersion of styrene-butadiene rubber particles (rubber binder, thermal decomposition temperature: 250° C., average volume-based particle size: 0.3 μm); and 50 parts by mass of a 1 mass % aqueous solution of carboxymethyl cellulose (water-soluble high molecular compound B, thermal decomposition temperature: 250° C., degree of swelling: 5%, viscosity of 1 mass % aqueous solution (25° C.) 4,000 mPa·s). This negative electrode material mixture slurry was applied to both surfaces of a 10 μm-thick tough pitch copper foil (negative electrode current collector, purity of copper: 99.9%, softening temperature: 170° C.), and a coating film thus obtained was dried and rolled, thereby producing a negative electrode precursor. The total thickness of the negative electrode current collector and the negative electrode active material layer formed on both surfaces of the negative electrode current collector was 150 μm.

The negative electrode precursor obtained above was heated in a nitrogen atmosphere at 190° C. for 5 hours, thereby producing a negative electrode. Thereafter, this negative electrode was cut to a predetermined size, thereby obtaining a negative electrode plate in strip form. The tensile strength of this negative electrode was 10 N/cm. Also, the binding strength of the negative electrode active material layer was 15N. When a cross section of the cut piece obtained above was observed with a scanning electron microscope, artificial graphite particles with polyvinyl alcohol attached on their respective surfaces were observed.

### (3) Preparation of Non-Aqueous Electrolyte

A mixed solvent was obtained by adding 1 part by mass of vinylene carbonate to 99 parts by mass of a mixed solvent resulting from mixing ethylene carbonate and ethyl methyl carbonate at a volume ratio of 1:3. LiPF₆ was dissolved at a concentration of 1.0 mol/L in the mixed solvent thus obtained, thereby preparing a non-aqueous electrolyte.

### (4) Assembling of Electrode Group

One end of an aluminum lead was connected to the positive electrode current collector in the positive electrode plate obtained above. One end of a nickel lead was connected to the negative electrode current collector in the negative electrode plate obtained above. A wound-type electrode group was produced by interposing a 16 μm-thick polyethylene porous sheet (separator, trade name: Hipore, available from Asahi Kasei Corporation) between the positive electrode plate and the negative electrode plate obtained in the above manner and winding them. The wound-type electrode group thus obtained was pressed under a 25° C. atmosphere, thereby producing a flat electrode group. The pressing pressure was set to 0.5 MPa.

### (5) Fabrication of Battery

The flat electrode group obtained as above was inserted into a prismatic battery case made of stainless steel. A resin frame was attached to the upper part of the electrode group. The resin frame is for separating the electrode group from the sealing plate made of stainless steel, and for preventing the aluminum lead or the nickel lead from coming into contact with the battery case. The other end of the aluminum lead was connected to the bottom face of the sealing plate. The other end of the nickel lead was connected to the negative electrode terminal made of stainless steel. The negative electrode terminal was attached to the sealing plate, with a gasket made of propylene interposed therebetween. The sealing plate was placed at the opening of the battery case to be welded thereto. A non-aqueous electrolyte of a predetermined amount was injected into the battery case from the injection hole on the sealing plate. Thereafter, the injection hole was sealed with a sealing plug, thereby fabricating a non-aqueous electrolyte secondary battery.

### Example 2

A negative electrode was produced in the same manner as in Example 1, except for using as the water-soluble high molecular compound A, polyethylene oxide (thermal decomposition temperature: 200° C., degree of swelling: 12, viscosity of 1 mass % aqueous solution (25° C.): 1,000 mPa·s) in place of polyvinyl alcohol. The tensile strength of the negative electrode thus obtained was 10 N/cm, and the binding strength of the negative electrode active material layer was 15N. Except for using this negative electrode, a non-aqueous electrolyte secondary battery was fabricated in the same manner as in Example 1.

### Example 3

A negative electrode was produced in the same manner as in Example 1, except for using as the rubber binder, butadiene rubber particles (thermal decomposition temperature: 350° C., average volume-based particle size: 0.3 μm) in place of styrene-butadiene rubber particles. The tensile strength of the negative electrode thus obtained was 10 N/cm, and the binding strength of the negative electrode active material layer was 15 N. Except for using this negative electrode, a non-aqueous electrolyte secondary battery was fabricated in the same manner as in Example 1.

### Example 4

A negative electrode was produced in the same manner as in Example 1, except for using as the water-soluble high molecular compound A, carboxymethyl cellulose (thermal decomposition temperature: 250° C., degree of swelling: 12, viscosity of 1 mass % aqueous solution (25° C.): 1,000 mPa·s) in place of polyvinyl alcohol. The tensile strength of the negative electrode thus obtained was 10 N/cm, and the binding strength of the negative electrode active material layer was 15N. Except for using this negative electrode, a non-aqueous electrolyte secondary battery was fabricated in the same manner as in Example 1.

### Example 5

A negative electrode was produced in the same manner as in Example 1, except for using as the water-soluble high molecular compound B, Na salt of carboxymethyl cellulose (thermal decomposition temperature: 250° C., degree of swelling: 5%, viscosity of 1 mass % aqueous solution (25° C.): 4,000 mPa·s) in place of carboxymethyl cellulose. The tensile strength of the negative electrode thus obtained was 10 N/cm, and the binding strength of the negative electrode active material layer was 15 N. Except for using this negative electrode, a non-aqueous electrolyte secondary battery was fabricated in the same manner as in Example 1.

### Example 6

A negative electrode was produced in the same manner as in Example 1, except for using as the negative electrode current collector, tough pitch copper foil (negative electrode current collector, purity of copper: 99.99%) having a thickness of 10 μm and a softening temperature of 140° C. The tensile strength of the negative electrode thus obtained was 10 N/cm, and the binding strength of the negative electrode active material layer was 15 N. Except for using this negative electrode, a non-aqueous electrolyte secondary battery was fabricated in the same manner as in Example 1.

### Example 7

A negative electrode was produced in the same manner as in Example 1, except for: using as the negative electrode current collector, tough pitch copper foil (negative electrode current collector, purity of copper: 99.5%) having a thickness of 10 μm and a softening temperature of 220° C.; and heating the resultant negative electrode precursor obtained in a nitrogen atmosphere at 220° C. for 5 hours. The tensile strength of the negative electrode thus obtained was 10 N/cm, and the binding strength of the negative electrode active material layer was 14N. A non-aqueous electrolyte secondary battery was fabricated with use of this negative electrode, in the same manner as in Example 1.

### Example 8

A negative electrode was produced in the same manner as in Example 1, except for using as the negative electrode current collector, tough pitch copper foil (negative electrode current collector, purity of copper: 99.99%) having a thickness of 10 μm and a softening temperature of 140° C. The tensile strength of the negative electrode thus obtained was 10 N/cm, and the binding strength of the negative electrode active material layer was 15 N. Except for using this negative electrode, a non-aqueous electrolyte secondary battery was fabricated in the same manner as in Example 1.

### Example 9

A negative electrode material mixture slurry was prepared in the same manner as in Example 1, except for using: carboxymethyl cellulose (water-soluble high molecular compound B, thermal decomposition temperature: 260° C., degree of swelling: 5%, viscosity of 1 mass % aqueous solution (25° C.) 4,000 mPa·s) as the water-soluble high molecular compound A; Na salt of carboxymethyl cellulose (thermal decomposition temperature: 260° C., degree of swelling: 12%, viscosity of 1 mass % aqueous solution: 4,000 mPa·s) as the water-soluble high molecular compound B; and styrene-butadiene rubber particles (rubber binder, thermal decomposition temperature: 260° C., average volume-based particle size: 0.3 μm) as the rubber binder.

This negative electrode material mixture slurry was applied to both surfaces of electrolytic copper foil (negative electrode current collector, softening temperature: 250° C.) having a thickness of 10 μm, and a coating film thus obtained was dried and rolled, thereby producing a negative electrode precursor. Except for using the negative electrode precursor thus obtained and changing the heating temperature from 170° C. to 250° C., a negative electrode was produced in the same manner as in Example 1. The tensile strength of the negative electrode thus obtained was 10 N/cm, and the binding strength of the negative electrode active material layer was 10 N. Except for using this negative electrode, a non-aqueous electrolyte secondary battery was fabricated in the same manner as in Example 1.

### Example 10

A negative electrode was produced in the same manner as in Example 1, except for using as the rubber binder, styrene-butadiene rubber particles (thermal decomposition temperature: 220° C.) having an average volume-based particle size of 2 μm. The tensile strength of the negative electrode thus obtained was 15 N/cm, and the binding strength of the negative electrode active material layer was 10 N. Except for using this negative electrode, a non-aqueous electrolyte secondary battery was fabricated in the same manner as in Example 1.

### Example 11

A negative electrode was produced in the same manner as in Example 1, except for using as the rubber binder, styrene-butadiene rubber particles (thermal decomposition temperature: 220° C.) having an average volume-based particle size of 3 μm. The tensile strength of the negative electrode thus obtained was 15 N/cm, and the binding strength of the negative electrode active material layer was 8 N. Except for using this negative electrode, a non-aqueous electrolyte secondary battery was fabricated in the same manner as in Example 1.

### Example 12

A negative electrode was produced in the same manner as in Example 1, except for using as the water-soluble high molecular compound A, polyvinyl alcohol (thermal decomposition temperature: 230° C., degree of swelling: 8%, viscosity of 1 mass % aqueous solution (25° C.): 1,000 mPa·s) in place of polyvinyl alcohol. The tensile strength of the negative electrode thus obtained was 10 N/cm, and the binding strength of the negative electrode active material layer was 15N. Except for using this negative electrode, a non-aqueous electrolyte secondary battery was fabricated in the same manner as in Example 1.

### Example 13

A negative electrode was produced in the same manner as in Example 1, except for using Na salt of cellulose (thermal decomposition temperature: 250° C., degree of swelling: 12%, viscosity of 1 mass % aqueous solution (25° C.): 4,000 mPa·s) as the water-soluble high molecular compound B. The tensile strength of the negative electrode thus obtained was 10 N/cm, and the binding strength of the negative electrode active material layer was 15 N. Except for using this negative electrode, a non-aqueous electrolyte secondary battery was fabricated in the same manner as in Example 1.

### Comparative Example 1

A negative electrode was produced in the same manner as in Example 1, except for changing the heat treatment temperature for the negative electrode precursor from 190° C. to 110° C. The tensile strength of the negative electrode thus obtained was 20 N/cm, and the binding strength of the negative electrode active material layer was 15N. Except for using this negative electrode, a non-aqueous electrolyte secondary battery was fabricated in the same manner as in Example 1.

### Comparative Example 2

A negative electrode was produced in the same manner as in Example 1, except for not using polyvinyl alcohol which is the water-soluble high molecular compound A. The tensile strength of the negative electrode thus obtained was 10 N/cm, and the binding strength of the negative electrode active material layer was 15 N. Except for using this negative electrode, a non-aqueous electrolyte secondary battery was fabricated in the same manner as in Example 1.

### Comparative Example 3

A negative electrode was produced in the same manner as in Example 1, except for using as the water-soluble high molecular compound A, polyvinyl alcohol whose thermal decomposition temperature is 160° C. in place of polyvinyl alcohol whose thermal decomposition temperature is 230° C. The tensile strength of the negative electrode thus obtained was 10 N/cm, and the binding strength of the negative electrode active material layer was 5 N. Except for using this negative electrode, a non-aqueous electrolyte secondary battery was fabricated in the same manner as in Example 1.

### Comparative Example 4

A negative electrode was produced in the same manner as in Example 1, except for using as the water-soluble high molecular compound B, carboxymethyl cellulose whose thermal decomposition temperature is 160° C. in place of carboxymethyl cellulose whose thermal decomposition temperature is 250° C. (Example 1). The tensile strength of the negative electrode thus obtained was 15 N/cm, and the binding strength of the negative electrode active material layer was 3 N. Except for using this negative electrode, a non-aqueous electrolyte secondary battery was fabricated in the same manner as in Example 1

### Comparative Example 5

A non-aqueous electrolyte secondary battery was fabricated in the same manner as in Example 1, except for using as the rubber binder, styrene-butadiene rubber particles (average volume-based particle size: 0.3 μm) whose thermal decomposition temperature is 150° C. in place of styrene-butadiene rubber particles whose thermal decomposition temperature is 250° C.

### Comparative Example 6

A non-aqueous electrolyte secondary battery was fabricated in the same manner as in Example 1, except for using a negative electrode produced in the following manner. That is, in Comparative Example 3, a negative electrode material mixture slurry was prepared by mixing all at once with water, a negative electrode active material, a water-soluble high molecular compound A, a rubber binder, and a water-soluble high molecular compound B, without forming a coating layer comprising the water-soluble high molecular compound A on the surface of the negative electrode active material.

### [Production of Negative Electrode]

Scale-like artificial graphite was pulverized and sieved, and the average volume-based particle size was adjusted to 20 μm. The resultant was designated as a negative electrode active material. A negative electrode material mixture slurry was prepared by mixing with a double-arm kneader: 100 parts by mass of this negative electrode active material; 20 parts by mass of a 3 mass % aqueous solution (viscosity at 25° C.: 5,000 cP) of polyvinyl alcohol (water-soluble high molecular compound A, thermal decomposition temperature: 230° C.); 1 part by mass of an aqueous dispersion of styrene-butadiene rubber particles (rubber binder, thermal decomposition temperature: 250° C., average volume-based particle size: 0.3 μm); and 50 parts by mass of a 1 mass % aqueous solution of carboxymethyl cellulose (water-soluble high molecular compound B, thermal decomposition temperature: 25° C.)

A negative electrode precursor was produced in the same manner as in Example 1, except for using the negative electrode material mixture slurry obtained above. The total thickness of the negative electrode current collector and the negative electrode active material layer on both surfaces thereof, was 150 μm. The negative electrode precursor thus obtained was heated in the same manner as in Example 1, thereby producing a negative electrode. The tensile strength of this negative electrode was 10 N/cm. Also, the binding strength of the negative electrode active material layer was 5 N.

### [Battery Capacity Evaluation]

With respect to the non-aqueous electrolyte secondary batteries of Examples 1 to 13 and Comparative Examples 1 to 6, a charge-discharge cycle was repeated 3 times under the conditions as below. The discharge capacity at the 3rd cycle was obtained and designated as the battery capacity. In the charge-discharge cycle, under the condition as below, first, constant-current charge was conducted followed by constant-voltage charge and then constant-current discharge was conducted. The results are shown on Table 1.

Constant-Current charge: 200 mA, end-of-charge voltage of 4.2 V

Constant-Voltage charge: end-of-charge current of 20 mA, rest time of 20 minutes

Constant-Current discharge: current of 200 mA, end-of-discharge voltage of 2.5 V, rest time of 20 minutes

### [Cycle Characteristics Evaluation]

With respect to the non-aqueous electrolyte secondary batteries of Examples 1 to 13 and Comparative Examples 1 to 6, a charge-discharge cycle was repeated 500 times at 45° C. under the conditions as below. In the charge-discharge cycle, under the condition as below, first, constant-current charge was conducted followed by constant-voltage charge and then constant-current discharge was conducted.

Constant-Current charge: charge current value of 500 mA/end-of-charge voltage of 4.2 V

Constant-Voltage charge: charge voltage value of 4.2 V/end-of-charge current of 100 mA

Constant-Current discharge: discharge current value of 500 mA/end-of-discharge voltage of 3 V

Also, the capacity retention rate (%) was obtained by the equation as below. The results are shown on Table 1.

Capacity retention rate (%)=(discharge capacity at 500th cycle/discharge capacity at 1st cycle)×100

### [Battery Swelling Evaluation]

With respect to the batteries after the cycle characteristics evaluation, the extent of battery swelling was measured. The value (mm) resulting from subtracting the battery thickness before the cycle characteristics evaluation from the battery thickness thereafter was designated as the extent of battery swelling. The results are shown on Table 1.

TABLE 1

| | Battery | Capacity | Extent of battery |
|---|---|---|---|
| | capacity | retention rate | swelling |
| | (mAh) | (%) | (mm) |
| Ex. 1 | 1,000 | 80 | 0.15 |
| Ex. 2 | 1,000 | 80 | 0.15 |
| Ex. 3 | 1,000 | 80 | 0.15 |
| Ex. 4 | 1,000 | 80 | 0.15 |
| Ex. 5 | 1,000 | 80 | 0.15 |
| Ex. 6 | 1,000 | 80 | 0.15 |
| Ex. 7 | 1,000 | 80 | 0.15 |
| Ex. 8 | 1,000 | 80 | 0.15 |
| Ex. 9 | 1,000 | 70 | 0.30 |
| Ex. 10 | 1,000 | 80 | 0.15 |
| Ex. 11 | 1,000 | 70 | 0.30 |
| Ex. 12 | 1,000 | 70 | 0.30 |
| Ex. 13 | 1,000 | 70 | 0.30 |
| Comp. Ex. 1 | 1,000 | 50 | 0.80 |
| Comp. Ex. 2 | 1,000 | 50 | 0.80 |
| Comp. Ex. 3 | 1,000 | 30 | 1.00 |
| Comp. Ex. 4 | 1,000 | 30 | 1.00 |
| Comp. Ex. 5 | 1,000 | 10 | 1.00 |
| Comp. Ex. 6 | 1,000 | 50 | 0.80 |

It is evident from Table 1, that with respect to the batteries of Examples 1 to 13, decrease in discharge capacity is small even when charge and discharge are repeated under extremely severe conditions, such being constant-current charge conducted with an end-of-charge voltage of 4.2 V and constant-voltage charge conducted at a charge voltage of 4.2 V, and battery performance can be maintained at a high level for a long period of time. Further, it is evident that battery swelling occurs at an extremely lesser extent. This is presumably due to separation of the negative electrode active material layer from the negative electrode current collector occurring at a significantly lesser extent, even with increase in the number of charge-discharge cycles.

Each of the batteries of Examples 1 to 13 and Comparative Examples 1 to 6 after the cycle characteristics evaluation was disassembled, the electrode group was taken out and unwound, and a cross section of the negative electrode was observed at 10 random locations with a microscope. As a result: separation of the negative electrode active material layer from the negative electrode current collector was not observed in the batteries of Examples 1 to 8 and 10; slight separation was observed at 1 to 2 locations among the 10 locations in the batteries of Examples 9 and 11 to 13; and separation was observed at half or more of the 10 locations in the batteries of Comparative Examples 1 to 6. From the above, it is evident that separation of the negative electrode active material layer from the negative electrode current collector can be suppressed remarkably, by employing the constitution of the present invention.

Although the present invention was described herein with reference to a currently preferred embodiment, a limited interpretation should not be made for such disclosure. Variations and modifications would become doubtlessly obvious to a person skilled in a technical field belonging to the present invention, who reads the above disclosure. Therefore, the scope of the claims attached should be interpreted as encompassing all variations and modifications without departing from the true spirit and scope of the present invention.

### INDUSTRIAL APPLICABILITY

The non-aqueous electrolyte secondary battery of the present invention can be used for the same applications for which a conventional non-aqueous electrolyte secondary is used, and is particularly useful as main power sources or supplementary power sources for electronic equipments, electric equipments, machine tools, vehicles, energy storage devices, and the like. Electronic equipments include personal computers, cell phones, mobile equipments, personal digital assistants, portable game players, and the like. Electric equipments include vacuum cleaners, video cameras, and the like. Machine tools include electric tools, robots, and the like. Vehicles include electric vehicles, hybrid electric vehicles, plug-in hybrid electric vehicles, fuel cell vehicles, and the like. Energy storage devices include permanent power supply and the like.

1. A negative electrode for a non-aqueous electrolyte secondary battery which comprises a non-aqueous electrolyte serving as an ion conductor, said negative electrode comprising: a negative electrode current collector; and a negative electrode active material layer supported on a surface of said negative electrode current collector,
wherein said negative electrode active material layer comprises: (1) a negative electrode active material which expands and contracts by absorbing and desorbing lithium ions; (2) a rubber binder whose thermal decomposition temperature is equal to or higher than the softening temperature of said negative electrode current collector; (3) a water-soluble high molecular compound A whose thermal decomposition temperature is equal to or higher than the softening temperature of said negative electrode current collector; and (4) a water-soluble high molecular compound B whose thermal decomposition temperature is equal to or higher than the softening temperature of said negative electrode current collector and whose degree of swelling relative to said non-aqueous electrolyte is lower than that of said water-soluble high molecular compound A,
said negative electrode active material has on a surface, a coating layer comprising said water-soluble high molecular compound A, and
the tensile strength of said negative electrode is 15 N/cm or lower when the percentage elongation is 1% in the longitudinal direction.

2. The negative electrode for a non-aqueous electrolyte secondary battery in accordance with claim 1, wherein the degree of swelling of said water-soluble high molecular compound A relative to said non-aqueous electrolyte is 10% or higher, and the degree of swelling of said water-soluble high molecular compound B relative to said non-aqueous electrolyte is lower than 10%.

3. The negative electrode for a non-aqueous electrolyte secondary battery in accordance with claim 1, wherein the binding strength of said negative electrode active material layer is 10 N or more.

4. The negative electrode for a non-aqueous electrolyte secondary battery in accordance with claim 1, wherein the softening temperature of said negative electrode current collector is 130° C. to 230° C.

5. The negative electrode for a non-aqueous electrolyte secondary battery in accordance with claim 1, wherein said water-soluble high molecular compound A is at least one selected from polyvinyl alcohol and polyethylene oxide.

6. The negative electrode for a non-aqueous electrolyte secondary battery in accordance with claim 1, wherein the viscosity (25° C.) of a 1 mass % aqueous solution of said water-soluble high molecular compound A is 50 mPa·s to 2,000 mPa·s, and the viscosity (25° C.) of a 1 mass % aqueous solution of said water-soluble high molecular compound B is 1,500 mPa·s to 10,000 mPa·s.

7. The negative electrode for a non-aqueous electrolyte secondary battery in accordance with claim 1, wherein said rubber binder is a rubber binder particle having an average volume-based particle size of 0.1 μm to 2 μm.

8. A method for producing a negative electrode for a non-aqueous electrode secondary battery which comprises a non-aqueous electrolyte serving as an ion conductor, said negative electrode comprising: a negative electrode current collector; and a negative electrode active material layer supported on a surface of said negative electrode current collector, said method comprising the steps of:
allowing a surface of a negative electrode active material, which expands and contracts by absorbing and desorbing lithium ions, to be covered with a water-soluble high molecular compound A whose thermal decomposition temperature is equal to or higher than the softening temperature of said negative electrode current collector, thereby obtaining a negative electrode active material having a coating layer;
mixing together with a dispersant: said negative electrode active material having said coating layer; a rubber binder whose thermal decomposition temperature is equal to or higher than the softening temperature of said negative electrode current collector; and a water-soluble high molecular compound B whose thermal decomposition temperature is equal to or higher than the softening temperature of said negative electrode current collector and whose degree of swelling relative to said non-aqueous electrolyte is lower than that of said water-soluble high molecular compound A, thereby preparing a negative electrode material mixture slurry;
applying said negative electrode material mixture slurry on a surface of said negative electrode current collector, and then drying and rolling a coating film thus obtained, thereby obtaining a negative electrode precursor; and
heating said negative electrode precursor at a temperature equal to or higher than the softening temperature of said negative electrode current collector, thereby obtaining a negative electrode whose tensile strength is 15 N/cm or lower when the percentage elongation is 1% in the longitudinal direction.

9. The method for producing a negative electrode for a non-aqueous electrolyte secondary battery in accordance with claim 8, wherein the heating of said negative electrode precursor at a temperature equal to or higher than the softening temperature of said negative electrode current collector is carried out in vacuum or a non-oxidizing atmosphere.

10. A non-aqueous electrolyte secondary battery comprising: a positive electrode which absorbs and desorbs lithium ions; a negative electrode which absorbs and desorbs lithium ions; a separator interposed between said positive electrode and said negative electrode; and a non-aqueous electrolyte,
wherein said negative electrode is the negative electrode for a non-aqueous electrolyte secondary battery in accordance with claim 1.

11. The non-aqueous electrolyte secondary battery in accordance with claim 10, comprising a wound-type electrode group obtained by winding said positive electrode and said negative electrode with said separator interposed therebetween.

12. The non-aqueous electrolyte secondary battery in accordance with claim 10, wherein said positive electrode comprises: a positive electrode current collector; and a positive electrode active material layer supported on a surface of said positive electrode current collector and including a lithium-containing composite oxide as a positive electrode active material.
